(19) United States
(12) Patent Application Publication
(10) Pub. No.: US 2017/0165691 A1
(43) Pub. Date: Jun. 15, 2017

(54) PAINT SPRAYING DEVICE

(71) Applicant: BM TECH CO., LTD, Siheung-si (KR)

(72) Inventor: Jeong Hoon OH, Namyangju-si (KR)

(21) Appl. No.: 15/115,667

(22) PCT Filed: May 27, 2015
(86) PCT No.: PCT/KR2015/005317

§ 371 Date: Jul. 30, 2016

(30) Foreign Application Priority Data
Aug. 12, 2014 (KR) 10-2014-0104621

(51) Int. Cl. B05B 9/00; B05B 9/04; B05B 1/24

(52) U.S. Cl. CPC B05B 9/002; B05B 1/24; B05B 9/007; B05B 9/0403

(57) ABSTRACT

Disclosed is a paint spraying device for spraying paint onto a desired target in such a way that the paint spraying device can be easily moved, the paint can be promptly and uniformly heated so as to be liquefied, and a constant temperature of the paint can be maintained. The paint spraying device includes: a frame (100) with moving wheels (110) rotated by a motor, the moving wheels located on a lower surface of the frame; a housing (200) mounted on the frame (100), with a receiving space (210) formed therein, and an open discharge outlet formed in a lower part of the housing; a heater unit (300) provided in the receiving space (210) of the housing (200) so as to heat paint poured into the receiving space (210); a spraying pump (400) mounted on the frame (100), and connected to the discharge outlet so as to move the paint melted by the heater unit (300); and a spraying hose (500) of which a first end is connected to the spraying pump (400), and a second end is provided with a spraying gun (510) so as to spray the melted paint onto a location desired by a user.

### TECHNICAL FIELD

The present invention relates generally to a paint spraying device. More particularly, the present invention relates to a paint spraying device for spraying paint onto an object to be sprayed by heating and melting solid paint (including a water proof agent) at a constant temperature.

### BACKGROUND ART

In general, on a construction site, waterproofing is conducted after the construction of a facility is completed.

In this case, a high-adhesive waterproof agent is used for waterproofing the facility. In the conventional method, a solid waterproof agent (a high adhesive rubberized asphalt coated waterproof agent) is put in a drum, and the drum is heated so as to liquefy the solid waterproof agent. Thereafter, the liquefied waterproof agent is applied to the facility using a roller.

However, the waterproofing process according to the related art is complicated, and it takes long time. Thus, since working efficiency is low, many workers are needed. Accordingly, it is problematic in that the waterproofing process according to the related art is not economical.

Particularly, when the drum is heated, since only a surface temperature of the drum is increased, it is required to stir paint located in the middle of the drum.

Furthermore, according to the related art, a spraying hose is connected to the drum for easily spraying paint without a roller so as to increase working efficiency. However, when waterproofing is conducted in an underground site, since the spraying hose is extended, a temperature of a liquid waterproof agent is lowered. Thus, it is problematic in that the liquid paint may solidify. Further, it is also problematic in that a drum and a heater may not be moved to the underground site since they are too large and heavy to be moved.

### DISCLOSURE

### Technical Problem

Accordingly, the present invention has been made keeping in mind the above problems occurring in the related art, and the present invention is intended to propose a paint spraying device for spraying paint onto a desired target in such a way that the paint spraying device can be easily moved, the paint can be promptly and uniformly heated so as to be liquefied, and a constant temperature of the paint can be maintained.

### Technical Solution

In order to achieve the above object, according to one aspect of the present invention, there is provided a paint spraying device including: a frame 100 equipped with moving wheels 110 rotated by a motor, the moving wheels being located on a lower surface of the frame; a housing 200 mounted on the frame 100, with a receiving space 210 formed therein, and an open discharge outlet formed in a lower part of the housing; a heater unit 300 provided in the receiving space 210 of the housing 200 so as to heat paint poured into the receiving space 210; a spraying pump 400 mounted on the frame 100, and connected to the discharge outlet so as to move the paint melted by the heater unit 300; and a spraying hose 500 of which a first end is connected to the spraying pump 400, and a second end is provided with a spraying gun 510 so as to spray the melted paint onto a location desired by a user.

The heater unit 300 includes: a first heater portion 310 provided on an upper part of the frame, with a plurality of heater bars H horizontally disposed in the first heater portion in a state of being spaced apart from each other at predetermined intervals, in which the heater bars H are alternately disposed so that a left end of any one H of the heater bars is fixed to the housing 200, and a right end of a neighboring one H of the heater bars is fixed to the housing 200.

The heater unit 300 may further include: a second heater portion 320 provided on a position near the discharge outlet of the housing 200; and a third heater portion 330 provided below the first heater portion 310 of the housing 200 in a state of being vertically spaced apart from the first heater portion. The paint spraying device may further include: a steering support 600 rotatably mounted on the frame 100, and supporting the spraying hose 500.

The paint spraying device may further include: a plurality of exhaust pipes 700 formed in a pipe shape of which upper and lower ends are open such that the lower ends of the plurality of exhaust pipes communicate with an interior of the housing 200, and the upper ends of the plurality of exhaust pipes are open toward an upper part of the housing 200 so as to discharge gas generated from the interior of the housing 200 to an outside of the housing, in which the plurality of exhaust pipes 700 are disposed in a state of being spaced apart from each other in a horizontal direction and are configured such that heights of the lower ends of the exhaust pipes gradually increase in a direction from left to right.

The paint spraying device may further include: first temperature sensors 900 provided on the first, second, and third heater portions 310, 320, and 330 of the housing 200, respectively, and measuring temperatures of the first, second, and third heater portions; and a controller C separately controlling operations of the first, second, and third heater portions 310, 320, and 330 based on the temperatures measured by the first temperature sensors 900.

The paint spraying device may further include: a heat wire member 800 covering the spraying hose 500 and the spraying pump 400; a second temperature sensor (not shown) provided on the spraying hose 500, and measuring a temperature of the spraying hose 500; and a controller C controlling an operation of the heat wire member 800 based on the temperature measured by the second temperature sensor (not shown).

### Advantageous Effects

According to a paint spraying device of the present invention described above, it is advantageous as follows.

The paint spraying device can be easily moved by including moving wheels 110 provided on a lower surface of a frame 100. Further, the paint spraying device can promptly and uniformly melt solid paint by including a heater unit 300 in which heater bars H generating heat by electricity are disposed in a housing 200 in a state of being spaced apart from each other at predetermined intervals. Further, a spraying hose 500 can be easily aimed at an object to be sprayed in such a way that the spraying hose 500 is suspended from a steering support 600.

### DESCRIPTION OF DRAWINGS

FIG. 1 is a perspective view illustrating the first side of a paint spraying device according to an embodiment of the present invention;

FIG. 2 is a perspective view illustrated by cutting away a portion of a housing of the paint spraying device according to the embodiment of the present invention when viewed from the second side of the paint spraying device;

FIG. 3 is a plan view of a first heater portion of the paint spraying device according to the embodiment of the present invention;

FIG. 4 is a side sectional view of the housing of the paint spraying device according to the embodiment of the present invention; and

FIG. 5 is a front view of the paint spraying device according to the embodiment of the present invention.

### MODE FOR INVENTION

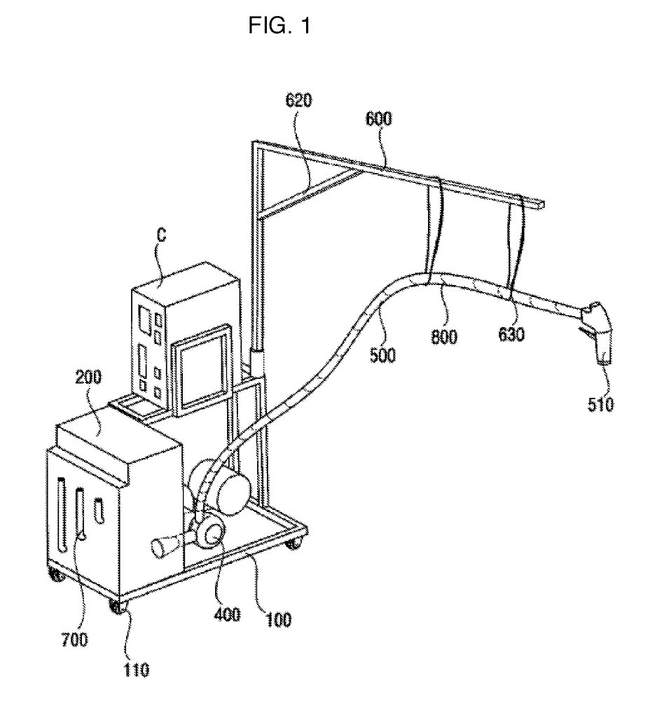

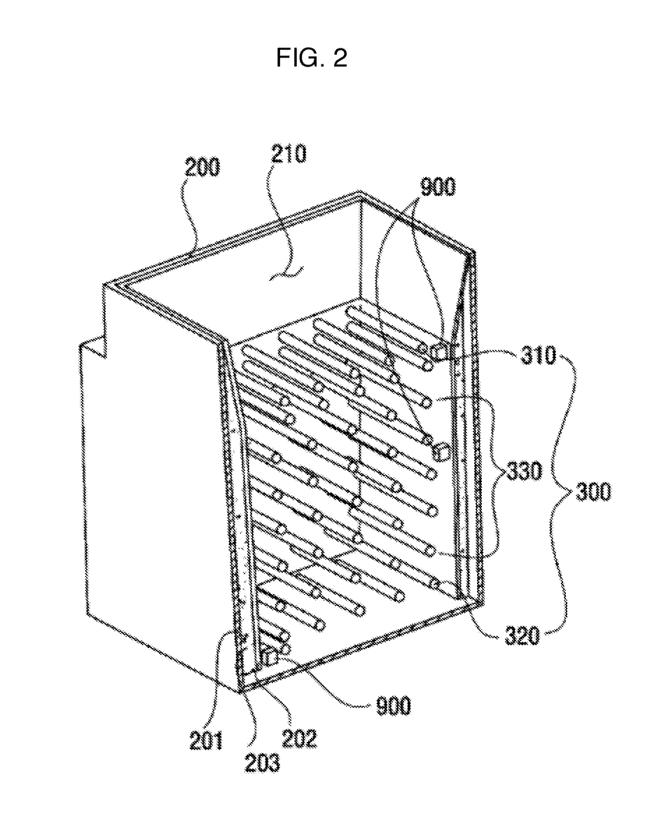

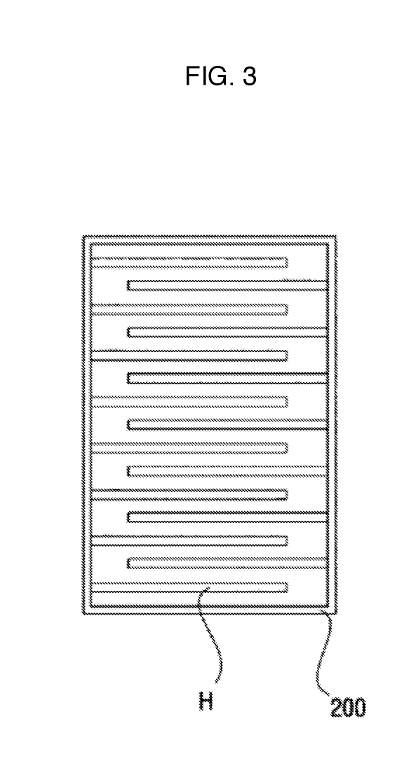

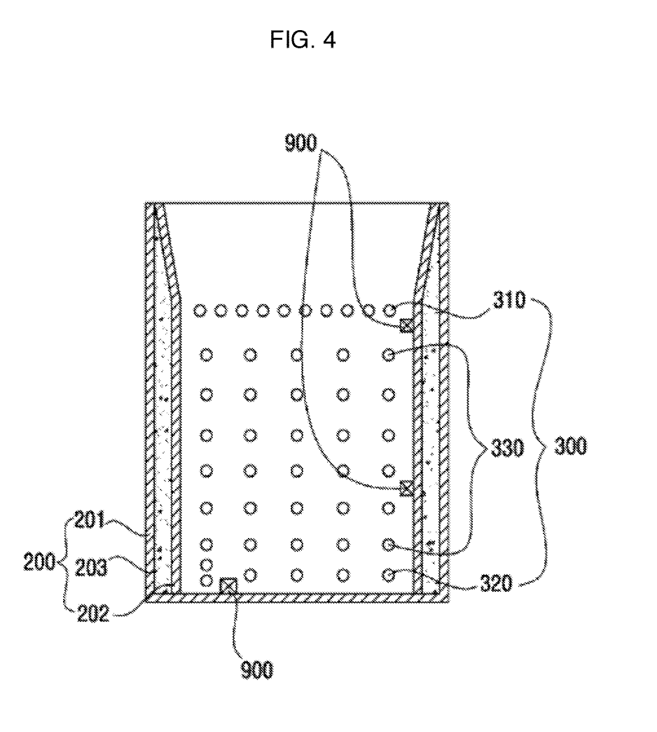

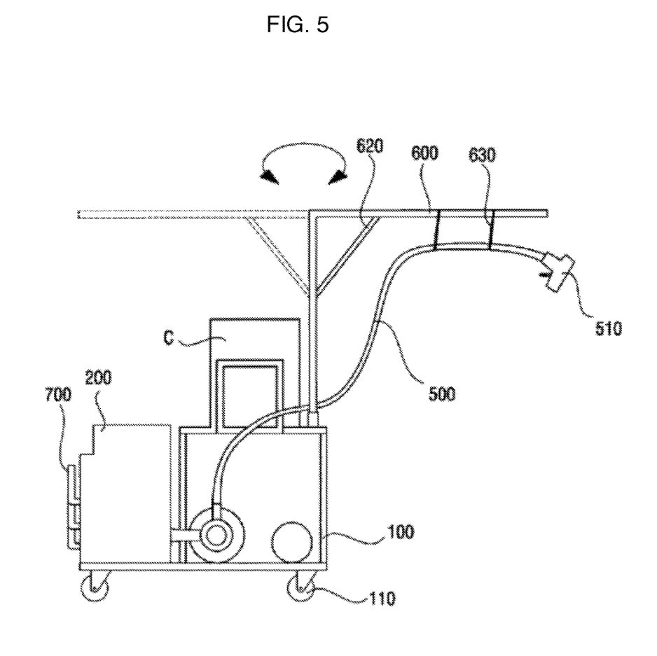

FIG. 1 is a perspective view illustrating a first side of a paint spraying device according to an embodiment of the present invention, FIG. 2 is a perspective view illustrated by cutting away a portion of a housing of the paint spraying device according to the embodiment of the present invention when viewed from a second side of the paint spraying device, FIG. 3 is a plan view of a first heater portion of the paint spraying device according to the embodiment of the present invention, FIG. 4 is a side sectional view of the housing of the paint spraying device according to the embodiment of the present invention, and FIG. 5 is a front view of the paint spraying device according to the embodiment of the present invention.

As shown in FIGS. 1 to 5, the paint spraying device according to the embodiment of the present invention includes: a frame 100, a housing 200, a heater unit 300, a spraying pump 400, a spraying hose 500, a steering support 600, exhaust pipes 700, a heat wire member 800, first temperature sensors 900, a second temperature sensor (not shown), and a controller C.

As shown in FIG. 1, the frame 100 is formed in an approximately hexahedral shape by connecting extrusions formed in a bar shape such that the controller C, which is described later, is provided on an upper part of the frame 100, and the housing 200 and the spraying pump 400, which are described later, are provided in the frame 100.

Furthermore, moving wheels 110 rotated by a motor are provided on a lower surface of the frame 100.

The moving wheels 110 are operated by an electric driving method generally used for an electric cart, and are provided on positions near the corners of the lower surface of the frame 100 so as to increase mobility of the frame 100.

The housing 200 is formed in an approximately hexahedral shape. Further, an inlet (not shown) is formed in an upper part of the housing such that paint is poured through the inlet. Further, a receiving space 210 is formed in the housing such that the heater unit 300, which is described later, is provided in the receiving space. Further, a discharge outlet (not shown) is formed in a lower part of the housing such that melted paint is discharged through the discharge outlet.

Although the discharge outlet is not illustrated in detail in the drawings, the discharge outlet is formed on a position near a second heater portion 320 of the heater unit 300 which is shown in FIG. 2 and is described later. That is, the discharge outlet is formed on a left side of a lower end of the housing 200. Further, the discharge outlet is connected to the spraying pump 400 which is described later.

The housing 200 is mounted on a left side in the frame 100, and is connected to the spraying pump 400.

Furthermore, as shown in FIG. 2, the housing 200 comprises an outer wall 201, an inner wall 202 defining the receiving space 210, and a heat insulating material 203 interposed between the outer wall 201 and the inner wall 202. Thus, a temperature of the receiving space 210 may be constantly maintained for a long time.

Meanwhile, the heater unit 300 is provided in the receiving space 210 of the housing 200, and changes solid paint poured into the receiving space 210 into liquid paint by heating the paint.

More specifically, as shown in FIG. 2, the heater unit 300 comprises the first, second, and third heater portions 310, 320, and 330.

The first heater portion 310 contacts solid paint first when the solid paint is poured into the inlet. Further, the first heater portion 310 heats the solid paint so as to be melted.

The first heater portion 310 comprises a plurality of heater bars H vertically protruding from the housing 200, and the plurality of heater bars H are disposed along a horizontal direction of the housing 200 in a state of being spaced apart from each other at predetermined intervals.

Accordingly, the poured solid paint is melted by the heater bars H of the first heater portion 310, and then falls through the space between the heater bars H.

Here, as shown in FIG. 3, the heater bars H are alternately disposed so that a left end of any one H of the heater bars is fixed to the housing 200, and a right end of a neighboring one H of the heater bars is fixed to the housing 200.

That is, the heater bars H are provided so that the left ends and the right ends of the heater bars are alternately fixed to the inner wall of the housing 200.

As described, the first heater portion 310 is configured such that the heater bars H are disposed along the horizontal direction of the housing 200 in a state of being spaced apart from each other at predetermined intervals, and the left ends and the right ends of the heater bars are alternately fixed to the inner wall of the housing 200. Thus, the heater bars H are prevented from interfering with each other, and safety is reinforced.

The second heater portion 320 is configured such that the heater bars H are provided in a position near the discharge outlet of the housing 200 in a state of being spaced apart from each other at predetermined intervals. Particularly, the heater bars H are densely disposed around the discharge outlet.

The second heater portion 320 continuously heats paint melted by the first heater portion 310 until the melted paint is discharged through the discharge outlet. Particularly, since the heater bars H are densely disposed around the discharge outlet, the melted paint may be prevented from solidifying while the melted paint is discharged.

The third heater portion 330 is configured such that the heater bars H are disposed between the first and second heater portions 310 and 320 of the housing 200 in a state of being vertically spaced apart from the first and second heater portions. Further, intervals between the heater bars H of the third heater portion 330 are wider than intervals between the heater bars H of the first heater portion 310.

When a working process is suspended in a state where paint remains in the receiving space 210, the paint is solidified. Thus, the third heater portion 330 reheats the solid paint in the receiving space 210 so as to change the solid paint into liquid paint.

That is, the third heater portion 330 is not for reheating the paint melted by the first heater portion 310, but is for heating the paint remaining in the receiving space 210.

Meanwhile, the spraying pump 400 sucks the paint melted by the heater unit 300, and discharges the melted paint into the spraying hose 500 which is described later.

A general water pump is utilized as the spraying pump 400. Further, the spraying pump 400 is provided in the frame 100, and is connected to the receiving space 210 and the spraying hose 500.

The spraying pump 400 connected to the discharge outlet of the housing 200 sucks liquid paint in the receiving space 210, and discharges the liquid paint into the spraying hose 500.

Here, as shown in FIG. 1, an outer surface of the spraying pump 400 is covered with the heat wire member 800 so as to maintain the temperature of the paint. Further, an outer surface of the heat wire member 800 is covered with the heat insulating material for heat insulation.

The spraying hose 500 is made of a material having chemical and thermal resistance. Further, a first end of the spraying hose 500 is connected to the spraying pump 400, and a second end of the spraying hose 500 is provided with a spraying gun 510.

Since a general spraying gun for a high pressure washer is utilized as the spraying gun 510, detailed descriptions of the spraying gun 510 are omitted.

Furthermore, in the same manner as the spraying pump 400, an outer surface of the spraying hose 500 is covered with the heat wire member 800 so as to maintain the temperature of paint, and an outer surface of the heat wire member 800 is covered with the heat insulating material for heat insulation.

The spraying hose 500 functions as a passage for moving the liquid paint supplied from the spraying pump 400 to an object to be sprayed. The liquid paint passing through the spraying hose 500 may be prevented from being solidified by the heat wire member 800.

Meanwhile, the spraying gun 510 of the spraying hose 500 is aimed at the object to be sprayed in a state where the spraying hose 500 is suspended from the steering support 600.

As shown in FIGS. 1 and 5, the steering support 600 is formed in an approximately inverted and reversed ‘L’ shape. Further, a lower end of a vertically long bar is rotatably coupled to the frame 100.

In this case, a horizontal bar of the steering support 600 rotates 360° based on the vertical bar of the steering support 600. Thus, the spraying hose 500 may be easily moved in all directions of the frame 100.

Furthermore, an auxiliary support 620 is diagonally provided between the vertical and horizontal bars of the steering support 600. Thus, durability of the steering support 600 is increased.

The spraying hose 500 is movably suspended from the steering support 600 by using a connection means 630, such as a cable.

Since the steering support 600 that supports the spraying hose 500 and rotates 360° is provided, weight of the spraying hose 500 is decreased and a direction of the spraying hose 500 may easily be changed when the spraying hose 500 is aimed at the object to be sprayed. Thus, working efficiency is increased.

Meanwhile, as shown in FIG. 1, the exhaust pipes 700 for discharging gas generated from the receiving space 210 into an outside of the housing 200 are provided on a side surface of the housing 200.

The exhaust pipes 700 are formed in a pipe shape, and upper and lower ends of the exhaust pipes 700 are open. The lower ends of the exhaust pipes communicate with an interior of the housing 200, and the upper ends of the exhaust pipes are open toward the upper part of the housing 200 so as to discharge gas generated from the interior of the housing 200 into the outside of the housing.

Furthermore, the number of exhaust pipes 700 is approximately three. Further, the exhaust pipes 700 are disposed in a state of being spaced apart from each other in a horizontal direction of the housing 200, and are configured such that heights of the lower ends of the exhaust pipes gradually increase in a direction from left to right so that generated gas is promptly discharged from the receiving space 210.

Meanwhile, the heat wire member 800 covers the spraying pump 400 and the spraying hose 500, and heats the spraying pump 400 and the spraying hose 500 so that melted paint passing through the spraying pump 400 and the spraying hose 500 is prevented from being cooled.

The first temperature sensors 900 are provided around the first, second, and third heater portions 310, 320, and 330, respectively. Further, the first temperature sensors 900 measure temperatures of the first, second, and third heater portions 310, 320, and 330, and transmit the measured temperatures to the controller C.

In the same manner, the second temperature sensor (not shown) is provided on the spraying hose 500. Further, the second temperature sensor measures a temperature of the spraying hose 500, and transmits the measured temperature to the controller C.

The controller C is mounted on the upper part of the frame 100. Further, the controller C separately controls operations of the first, second, and third heater portions 310, 320, and 330 in such a way that the controller C separately receives temperatures of the first, second, and third heater portions 310, 320, and 330 by the first temperature sensors 900.

That is, it is desirable that the first heater portion 310 is operated when paint is poured, the second heater portion 320 is operated when paint is poured and the paint is discharged, and the third heater portion 330 is operated for reuse of paint when the paint remaining in the receiving space 210 is solidified. Further, it is also desirable that the first, second, and third heater portions 310, 320, and 330 are separately controlled by the controller C so that the temperatures of the first, second, and third heater portions 310, 320, and 330 are appropriately maintained depending on respective functions thereof.

Here, the second heater portion 320 is operated in conjunction with the third heater portions 330, and paint in the lower part of the housing 200 may be melted.

Furthermore, the controller C controls an operation of the heat wire member 800 so as to maintain the temperature of the spraying hose 500 by the second temperature sensor (not shown).

It is advantageous in that uniform quality of paint may be achieved by maintaining a constant temperature of the paint passing through the spraying hose 500 in such a way that a temperature of the heat wire member 800 is controlled by the second temperature sensor (not shown) and the controller C.

As described above, the paint spraying device according to the embodiment of the present invention may be easily moved by including the moving wheels 110 provided on the lower surface of the frame 100. Further, the paint spraying device may promptly and uniformly melt solid paint by including the heater unit 300 in which the heater bars H generating heat by electricity are disposed in the housing 200 in a state of being spaced apart from each other at predetermined intervals. Further, the spraying hose 500 may be easily aimed at the object to be sprayed in such a way that the spraying hose 500 is provided at the steering support 600.

Although the preferred embodiments of the present invention have been disclosed for illustrative purposes, the scope and spirit of the present invention are not limited thereto, and those skilled in the art will appreciate that various modifications, additions and substitutions are possible, without departing from the scope and spirit of the invention as disclosed in the accompanying claims.

1. A paint spraying device comprising:
a frame equipped with moving wheels rotated by a motor, the moving wheels being located on a lower surface of the frame;
a housing mounted on the frame, with a receiving space formed therein, and an open discharge outlet formed in a lower part of the housing;
a heater unit provided in the receiving space of the housing so as to heat paint poured into the receiving space; a spraying pump mounted on the frame, and connected to the discharge outlet so as to move the paint melted by the heater unit; and
a spraying hose of which a first end is connected to the spraying pump, and a second end is provided with a spraying gun so as to spray the melted paint onto a location desired by a user, wherein the heater unit includes:
a first heater portion provided on an upper part of the frame, with a plurality of heater bars (H) horizontally disposed in the first heater portion in a state of being spaced apart from each other at predetermined intervals, wherein the heater bars (H) are alternately disposed so that a left end of any one (H) of the heater bars is fixed to the housing, and a right end of a neighboring one (H) of the heater bars is fixed to the housing.

2. The paint spraying device of claim 1, wherein the heater unit further includes:
a second heater portion provided on a position near the discharge outlet of the housing; and
a third heater portion provided between the first and second heater portions of the housing in a state of being vertically spaced apart from the first and second heater portions.

3. The paint spraying device of claim 1, further comprising:
a steering support rotatably mounted on the frame, and supporting the spraying hose.

4. The paint spraying device of claim 1, further comprising:
a plurality of exhaust pipes formed in a pipe shape of which upper and lower ends are open such that the lower ends of the plurality of exhaust pipes communicate with an interior of the housing, and the upper ends of the plurality of exhaust pipes are open toward an upper part of the housing so as to discharge gas generated from the interior of the housing to an outside of the housing,
wherein the plurality of exhaust pipes are disposed in a state of being spaced apart from each other in a horizontal direction and are configured such that heights of the lower ends of the exhaust pipes gradually increase in a direction from left to right.

5. The paint spraying device of claim 2, further comprising:
first temperature sensors provided on the first, second, and third heater portions of the housing, respectively, and measuring temperatures of the first, second, and third heater portions; and
a controller (C) separately controlling operations of the first, second, and third heater portions based on the temperatures measured by the first temperature sensors.

6. The paint spraying device of claim 1, further comprising:
a heat wire member covering the spraying hose and the spraying pump;
a second temperature sensor provided on the spraying hose, and measuring a temperature of the spraying hose; and
a controller (C) controlling an operation of the heat wire member based on the temperature measured by the second temperature sensor.
